(19) United States
(12) Patent Application Publication
(10) Pub. No.: US 2022/0164768 A1
(43) Pub. Date: May 26, 2022

(54) System and Method for Optimized Delivery Based on Customer Location

(71) Applicant: Untether Capital, Inc., Markham (CA)

(72) Inventors: Michael MAY, Toronto (CA); Kirk TOBIAS, Markham (CA)

(21) Appl. No.: 17/503,112

(22) Filed: Oct. 15, 2021

Related U.S. Application Data
(63) Continuation of application No. PCT/CA2020/050512, filed on Apr. 16, 2020.
(60) Provisional application No. 62/834,658, filed on Apr. 16, 2019.

(51) Int. Cl. G06Q 10/08; H04W 4/021; G06Q 50/30

(52) U.S. Cl. CPC G06Q 10/0833; G06Q 50/30; H04W 4/021

(57) ABSTRACT

Disclosed is a method of delivering a product comprising receiving from a user device, an order, a preferred delivery location, and a user device location, assigning the order a preparation time, receiving an updated user device location at predetermined intervals, using the user device location and order preparation time, placing the order in a production queue to be prepared for delivery, determining if the user device is at the preferred delivery location, when the user device is at the preferred delivery location, delivering the order.

### CROSS-REFERENCE TO RELATED APPLICATIONS

The present application is a continuation of International PCT Application No. PCT/CA2020/050512 filed on Apr. 16, 2020, which claims priority from U.S. Provisional Application No. 62/834,658 filed on Apr. 16, 2019, both of which are incorporated herein by reference in their entireties.

### FIELD OF THE INVENTION

The invention relates to a system and method of optimized delivery based on customer location. In particular, the invention relates to a system and method of optimized delivery wherein the customer location is queried and the delivery time and overall delivery order at the point of sale is adjusted.

### DESCRIPTION OF THE PRIOR ART

Convenience is paramount in customer service. With less time available, customers will often choose their preferred vendor based on efficiency and convenience of service. This is especially true in the take-out food industry where orders are expected to be ready, and freshly prepared, on demand.

Traditional methods of take-out food involve entering a retail location, placing an order and waiting for the food to be prepared. Alternatively, drive-through environments also require a wait for the food or beverages to be ready. In order to speed up the process, often popular food items are pre-cooked and left in warming drawers, which decreases the quality of the product. In both the drive through and pick up environments, customers are required to wait for their order which is inconvenient.

In order to address this problem, some companies have developed order and delivery apps, particularly in the food industry. When using these apps, customers place an order and are given an approximate time until the order will be ready from the service location. This allows the customer to plan their time to get to the service location. However, if the customer is delayed, their food or beverage is sitting out and is not fresh when it is picked up. If the customer is early, they must wait for their order to be prepared which is an inconvenience.

Apps which organize the delivery of food to the customer location also exist. Due to the increase in traffic volume and delays, customers go out of their way and are inconvenienced when picking up food from a restaurant. As such, delivery apps have gained popularity. These apps provide the customer with an approximate delivery time based on the service location or delivery service needs. It is not customer driven, and as such, customers can be waiting for extended periods of time for their products. In addition, there is typically a significant cost associated with delivery and the timing of the delivery is not always optimal in terms of freshness and quality.

There remains a need for a customer-centered ordering/delivery system for increased convenience and quality for the user.

### SUMMARY OF THE INVENTION

The disclosure pertains to a method for delivering products to a user at a preferred pick up location. In particular, the disclosure pertains to a method for just in time delivery products to a user at a preferred pick up location that tracks the user location in order to ensure the order is ready when the user arrives at the pick up location.

In one embodiment, a method of delivering a product comprising receiving from a user device, an order, a preferred delivery location, and a user device location, assigning the order a preparation time, receiving an updated user device location at predetermined intervals, using the user device location and order preparation time, placing the order in a production queue to be prepared for delivery, determining if the user device is at the preferred delivery location, when the user device is at the preferred delivery location, delivering the order.

In another embodiment, the method of providing an order to a customer comprises the steps of
a) receiving an order from a user device;
b) determining the preferred delivery location;
c) assigning at least one preparation time to the order;
d) receiving a user device location;
e) using the user device location and order preparation time, determining if the order should be placed in a production queue to be prepared for delivery;
f) repeating steps d and e until the order is put in the production queue; then
g) determining if the user device is at the preferred delivery location; and
when the user device is at the preferred delivery location, providing the order.

In a further embodiment, the method uses the user device location and preferred delivery location to determine an estimated time to arrival and compares the estimated time to arrival to the order preparation time to determine if the order should be placed in a production queue.

In yet a further embodiment, the step of assigning the order at least one preparation time includes grouping the items into categories and assigning each category an order preparation time.

In yet a further embodiment, the step of assigning at least one preparation time includes assigning a preparation time to each item in the order.

In yet a further embodiment, the estimated time to arrival is used to assign one of a number of predetermined geozones and depending on the geozone assigned, adjusting the frequency of receiving the user device location.

In yet a further embodiment, after the order is put in the production queue a pickup slot location is assigned.

In yet a further embodiment, the pickup slot location is communicated to the user device.

In yet a further embodiment, isochrones and isoclines are used to determine the estimated time to arrival.

A preferred embodiment includes a system for sequencing a series of orders for production comprising an order tracker for receiving orders and corresponding user device locations. The order tracker has a first database for storing items from incoming orders and corresponding user device locations, and a second database for storing the preparation times associated with each item available for order. The order tracker also includes a processing means to assign each item in each order the corresponding preparation time and assign an estimated time to arrival to each order based on the associated user device location. The processing means is configured to receive periodically updated user device locations and update the first database with the new estimated time to arrival. The processer is further configured to use the preparation times and estimated time to arrival to determine if an order should be prepared. Once it has been determined that an order should be prepared, the order is displayed on a screen at a service location.

### BRIEF DESCRIPTION OF THE DRAWINGS

The features of the invention will become more apparent in the following detailed description in which reference is made to the appended drawings wherein:

FIG. 1 is a schematic of the overall ordering and delivery system;

FIG. 2A is a first part of a schematic of the overall ordering and delivery method;

FIG. 2B is a second part of a schematic of the overall ordering and delivery method;

FIG. 3 is a depiction of geo-zoning;

FIG. 4 is an example schematic of a truck layout;

FIG. 5A shows an example item ticket;

FIG. 5B shows an example slot ticket;

FIG. 6A shows an example order item label queue screen;

FIG. 6B shows an example staging slot print queue screen; and

FIG. 6C shows an example screen showing both the order item label queue and the staging slot print queue.

### DETAILED DESCRIPTION OF THE INVENTION

Many delivery or pick-up based applications, for example, food ordering and delivery/pick-up applications, are based on the service location notifying the customer when their food is ready for pick up. This type of application is driven by the needs of the service location as opposed to the needs of the customer. The system and method described herein is centered around using the customer location to notify the service location when the customer's order should be ready for pick up. By creating a customer-based system and method, the ordering and pick up process is more convenient for the customer and provides a fresher product. This leads to increased business for the service location as many customers make their ordering choices based on ease of use and convenience. While the examples described herein will reference specifically café or food pick-up type applications, it will be appreciated by a person skilled in the art that the same technology could be applied to any remote ordering system requiring customer pick up.

### The System Components

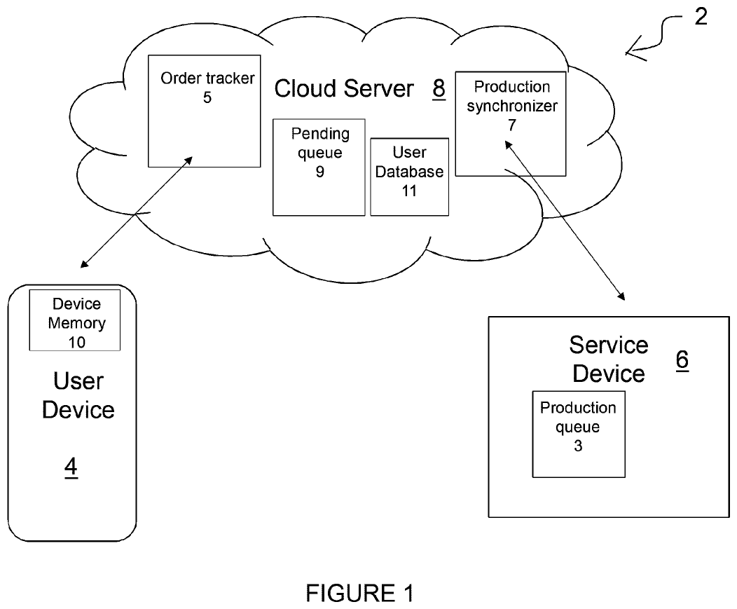

As shown in FIG. 1, the ordering and delivery system, shown generally as 2, requires the interaction between a user device 4 and a service device 6. This interaction preferably uses an intermediary server, such as cloud server 8 to facilitate the interaction between the user device 4 and the service device 6. The user device 4 can be any device known to a person skilled in the art that is portable, capable of location identification (for example with GPS) and capable of communication with a remote device, such as a cloud server 8. The service device 6 is typically a computer or point of sale-type system capable of taking orders and displaying orders for preparation to the staff of the service location. The service device 6 is capable of visually displaying the incoming orders for preparation in a production queue 3, for example on a screen or print out. The service device 6 works in combination with the cloud server 8 which stores a database containing a list of preparation times for each item available for the customer to order. Optionally, the database can contain information about the preparation time required for frequently ordered combination of items. For example, if the service location was a café, it may have the preparation time for a latte, and a latte with an egg sandwich.

The cloud server 8 contains an order tracker 5 processor which is used to track each user device 4 that has placed an order. This order tracker 5 contains information identifying the user and correlates that identification with the order. Furthermore, the order tracker processes location data sent from the user device 4 to determine the approximate time until the user arrives at the service location. This process is examined in more detail below. The cloud server 8 further includes a production synchronizer 7 which is used to determine when a specific order is sent to the service location for preparation. The pending queue 9, in the cloud server tracks each order corresponding to a particular service location. In an embodiment with multiple service locations, there would be multiple pending queues.

As would be known to a person skilled in the art, the computer system would be implemented with the aid of appropriate hardware and software and each device in the system may comprise a series of processors, memory and an input/output device. The memory would store instructions executed by the processor to perform methods described herein. It is understood that the system components described herein are just one example of the possible systems in which the invention may be implemented, and other system may have different architectures.

### Initial Set Up

The system 2 requires an initial user set up procedure. The user will access a platform for placing an order with a particular service location. This can be done, for example, by downloading an app specific to the service location. Alternatively, the app contains several service locations from which the customer could choose. The app could be installed on the user's device and stored in the device memory 10 or could be a web-based platform accessed via the internet.

The user provides details to the program necessary for placing and picking up an order. A user ID, payment method and permission for the program to access the devices location are provided to the system upon set up. Additionally, information such as home address, work address and car information, such as make, model, colour and/or license plate can be provided. The information can optionally be associated with a stored account for ease of repeatable use of the app. A user database 11 storing information on all registered accounts is kept in the cloud server 8. Payment methods include but are not limited to credit cards, gift cards, preloaded account balances, blockchain currencies, and/or digital wallets.

With the first order, the user will be presented with and asked to choose from one or more pick up locations. These locations are associated with the physical store or location of the service being ordered. Once a location has been selected, this information is associated with the user account to be used as a default option with future orders. Optionally, the user could enter their destination and the system queries the device location and uses a destination in combination with the device location to suggest pick up locations between the device location and the destination location. This embodiment is particularly useful in applications where the service location is mobile, such as a food truck, which can change location throughout the day. In the case where a user enters a work address, the work address could be used as the destination for the program to suggest possible pick-up locations.

The system is further designed to optionally track purchase history and any loyalty ratings or point. All the information associated with each account is stored in a database within the cloud server 8 and can be retrieved as pre-set options when the user repeatedly uses the app. This prevents the user from having to specify which service location they prefer or what items their typical order contains each time they place a new order.

### User Device System

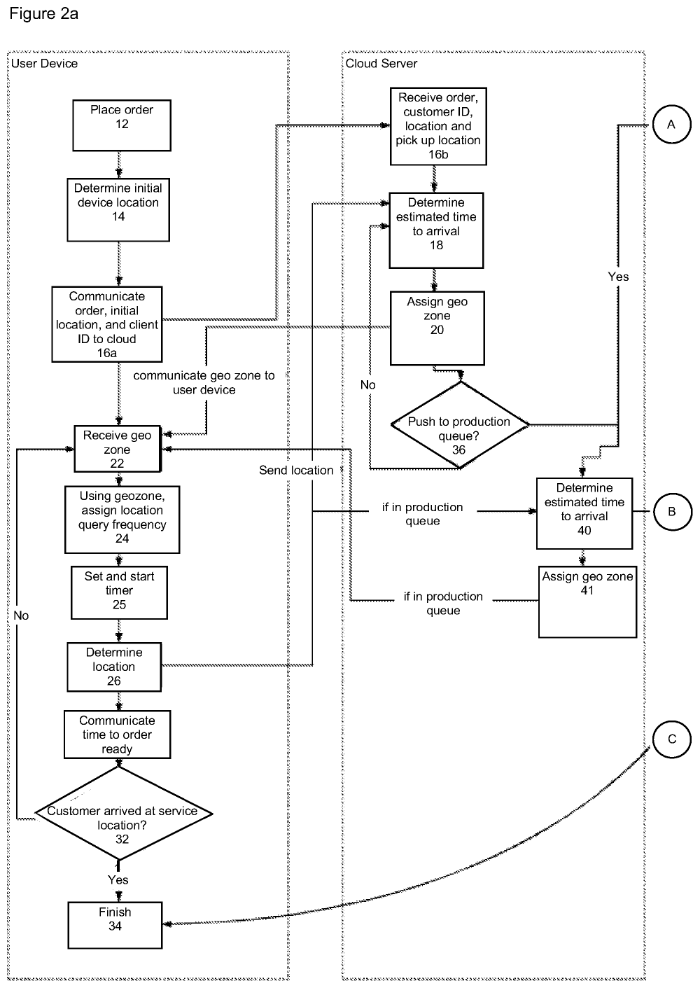

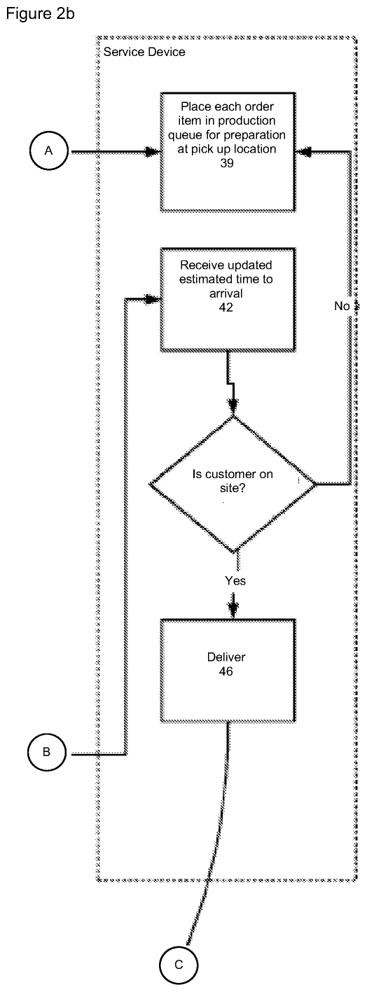

A flow diagram of the ordering and delivery process is shown in FIG. 2. The left-hand column represents the process of the user device 4, the center column represents processes preferably performed by the cloud server 8 and the right-hand column represents the processes preferably performed by the service device 6. In the preferred embodiments that follow, specific functions are described as completed by specific components of the system. However, it would be known to a person skilled in the art that many of the functions could be performed by a different element of the system without departing from the invention.

The user opens the app, logs in or otherwise identifies themselves. The user is then presented with at least one, but preferably a variety of items which they can order. Once the user selects the items they would like and select their preferred pick-up location, the user submits the order (step 12), the user device 4 is queried for its location. This initial device location is determined in step 14. The initial device location is then communicated, along with the order, customer ID and preferred pick up location to the order tracker 5 in the cloud server 8 (step 16a and 16b). The order tracker 5 stores this information and calculates an initial estimated time from the device location to the selected pick up location based on publicly available information such as traffic, method of transportation and map information (step 18). Using the estimated time to service location as a basepoint, the production synchronizer 7 can take into account current orders in the production queue 3 as well as orders in the pending order queue 9 for that particular service location to determine an approximate “ready time” for the user's order. While the actual delivery time will be provided based on the user location, the estimated delivery time will be provided to communicate to the customer that the order will be ready at a satisfactory time. If the service location is particularly busy, this feedback system could let the customer know that their order will not be ready at their time of arrival and the customer could change their pick-up location, cancel their order if necessary or adjust their plans and leave at a later time. From the estimated time to arrival, a dynamic geo zone is assigned by the order tracker 5 (step 20) and is communicated to phone (step 22).

Another useful feature is the capability of the cloud server to communicate a ready time to the user device if the user device goes offline for any reason. In this situation, when the user device comes back online, the app could alert the customer of the last known time that their order would be ready. Updates could also be provided as the user progresses to the service location.

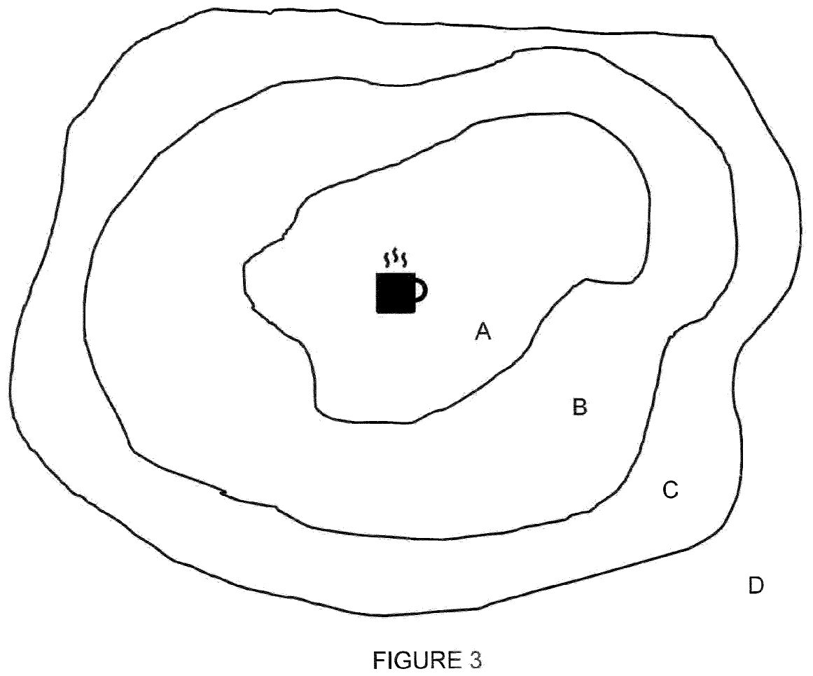

The concept of a dynamic geo zone is shown in FIG. 3. The user device 4 is assigned a zone based on its location and the estimated time it will take to get to the destination using the user selected mode of transportation and real-time or near-real-time travel information. Each zone is given a predetermined range of estimated arrival times. For example, a user device will be assigned to zone D if it has an estimated arrival time within the range of 40 minutes or greater, while zone C could include a range of 25-39 minutes, zone B, 10-24 minutes and zone A, up to 9 minutes away. These ranges are simply an example and would be subject to change based on the various applications of the ordering and delivery system.

Zone boundaries are determined based on several real-time, or near-real time factors, such as weather conditions, traffic conditions, speed limits on roads, among others. Logically, as these factors change, the boundaries of the zones also change. For example, if there is a traffic accident in zone B, the boundary may change to exclude the traffic accident from zone B as any car behind the accident would have an estimated time to the service location greater than 24 minutes. One way to determine the zone boundaries is to use isoclines and isochrones to determine the boundaries.

A predetermined location query frequency is also associated to each geo-zone. This defines how often the user device 4 will send its location to the cloud server 8 in order for the cloud server to identify the estimated time to the service location. Using the zones of FIG. 3 and the time ranges above as an example, the user device 4 may send its location to the cloud server 8 every 10 minutes in zone D, every 5 minutes in zone C, every 2 minutes in zone B and every 20 seconds in zone A. These frequencies are predetermined based on the needs for the specific application to which the app is directed.

Returning to FIG. 2, in step 22, the user device 4 receives an assigned starting geo-zone based on the initial estimated time to arrival at the service location determined by the order tracker 5. The estimated time to arrival at the service location is compared to the time ranges assigned to each dynamic geo zone and the corresponding location query frequency is applied (step 24). A timer is then used to determine when the next location query should occur (step 25). Upon expiry of the timer, the user device 4 location is determined in step 26 and sent to the order tracker 5. The new estimated time to arrival at the service location is calculated (step 18). In step 32, the user device 4 determines if the user is at the service location. If the answer is “yes”, the query loop is terminated at step 34. If the user's device 4 is not at the service location, steps 22 to 32 are repeated and the process then continues back to step 22. Once again, the new location of the user device 4 is sent to the order tracker to estimate the time to arrival at the service location and compares that estimate to the pre-set geo zone ranges and the corresponding query frequency is used to set the timer in step 24.

### Cloud and Service Location System

The cloud server receives an order, customer ID, service location for pick up and user device location from the user device (step 16b). The cloud server contains a processor that uses the device location to determine an initial estimated time to arrival at the service location based on the received user device location. This estimated time to arrival at the service location, service location for pick up, customer ID, and order are all stored in an order tracker 5 containing all orders for all service locations. The order tracker compares the incoming order to the items in the preparation time database and determines a preparation time for each item, a combination of items, or the entire order depending on the needs of specific nature of the retail store. For example, in a café environment, each item requiring preparation may be given a separate preparation time. However, if the application pertained to online grocery shopping where a variety of items needed to be collected from around the store, a preparation time for the entire order may be assigned based on, for example, the number of items and/or the number of departments from which items need to be collected.

Based on the estimated arrival time of the user and the preparation time of the order, the production synchronizer 7 in the cloud server 8 determines if the order should be pushed to the production queue (step 36) in the service location. More details on this step are outlined below. If the order is not ready to be pushed to the production queue, the order and customer ID are allocated to a pending order queue 9 specific to the service location for pick up. The pending order queue 9 acts as a preliminary estimate of the sequence in which the orders will need to be prepared. Once a new device location is received from the user device 4, the process continues at Step 18 until it is time to push the order to the production queue.

Determining when to Push to Production

There are several factors that influence when an order is pushed to the production queue 3 in the service device 6. First, the estimated time to service location and preparation time required for the order are the primary factors influencing the push to the production queue 3. However, the production synchronizer 7 in the cloud server 8 also receives updates on how long it will take the staff at the service location to clear all the orders currently in the production queue. For example, if there are 10 minutes worth of orders currently in the production queue, a user who is 15 minutes away will have their order pushed to the production queue when they are approximately 11 minutes away to ensure their order is filled when they arrive. By tracking the time left to clear the production queue and the estimated times for users to arrive at the service location, any potential conflicts can be resolved well before the customer arrives. Generally, the handling of these conflicts would be done by a manager at the service location, however certain factors, such as loyalty, could be taken into consideration to determine which orders would be delayed.

The production queue 3 is displayed and used by the staff of the service location to determine which order to prepare next. If the order has been pushed to production, the user device location is sent to the order tracker which determines the estimated time to arrival (step 40), assigns a geo zone and communicates it to the user device (step 41). The order tracker 5 sends the estimated time to arrival to the service device and in step 42, the service device 6 receives the updated estimated time to service location. The service device 6 determines if the customer is on site, either by the new estimated time to location being zero or alternatively the user device location being generally the same as the service location (step 44). Assuming the service location has followed the timing of the production queue, the order would be prepared for just in time delivery. As such, if the customer is on site, then the order is delivered (step 46). If the customer is not on site, then the process for the service device continues back at step 39 by re-ordering the production queue based on the new estimated time to arrival. Deliveries to cars can also be made easier using the optional car information identified in the initial set up. The user's car information could be displayed when during the delivery step 46 to notify the server what colour or type of car to which the order belongs. Other techniques to expedite delivery would be known to a person skilled in the art, such as numbered parking spots or a colour displayed on the user's device which could be displayed in the window of the car. This will expedite the delivery process.

This system is particularly useful in just in time delivery applications, for example café environments providing an “on the go” type service. It allows the food and beverages to be freshly prepared just in time for the customer's arrival. It is particularly convenient for the user as it uses their near-real time location to dictate when their order is being prepared. Therefore, the production queue is also adapted based on the near-real time user information. This results in fresher orders without requiring the inconvenience of the user waiting for it to be prepared.

Furthermore, it should be noted that while the steps of determining the estimated time of arrival 40 and assigning the geo zone 41 are shown as a separate step from the corresponding pre-production queue steps 18 and 20 respectively, it can be appreciated that these step could be performed by the same processor.

### Overflow Measures

While the service location would do their best to ensure that all items are delivered to customers at the customer arrival time, inevitably, during times of high volume, this will not always be possible. In times where the orders are delayed, the service device 6 can send notifications to the user device 4 with estimates of the order delay. This allows the user to adapt their plans or timing if necessary. Alternatively, the user could be presented with an optional cancel button to cancel their order if the delay is unacceptable to the customer.

The cloud server 8 is capable of prioritizing orders automatically based pre-determined criteria. One example of pre-determined criteria is customer loyalty. If there are several customers arriving at the same time, and the orders need to be prioritized, the system may choose which order will be prepared first by considering the loyalty of a customer. Customers with higher loyalty would have their orders prepared closest to the estimated user arrival time while customers with less loyalty would have their orders prepared either earlier (meaning the product would be waiting) or later (meaning the customer would have to wait). This loyalty ranking would be associated with the customers account and retrieved if necessary. The service device 6 could also prioritize first time users to ensure their experience was exceptional in hopes that they return as a repeat customer. As one can appreciate, the pre-determined criteria could be adapted to the particular service environment and priorities of the service location. The service device 6 program could also include an override function so that the production queue could be manually adjusted.

### Optimization and Tracking

The system is optimized by tracking certain information from the user device 4, cloud server 8 and the service device 6 processes.

With real time, or near-real time tracking of the user device 4, it is possible to track information pertaining to the user's habits. For example, the app could track the time it takes for the user to get from their home or starting location to the service location, the route or roads the user takes to get to the service location, the user's driving patterns and speeds, and the time it takes for a user to transition from one zone to another. All these patterns can be analyzed by the system to come up with more accurate estimations of when the customer will arrive at the service location.

The user routes and locations can also be used to identify travel patterns that can be used to determine high traffic or high frequency locations for the customers. This will allow for optimized placement of mobile locations, such as food trucks.

The service device 6 and cloud server 8 processes can be optimized by tracking the actual time it takes to prepare each order. This can be done on a location by location basis and taking into account which staff or teams of staff are working. Workplace trends can be determined at pre-set intervals throughout the day and order preparation times can be adjusted based on the daily performance of the service location staff. The performance and order preparation times can also be tracked based on the time of day and preparation times adjusted accordingly. If a service location team is falling particularly behind, the system could automatically notify a governing system which could arrange for more staff to be sent to the service location. Furthermore, orders can be tracked to ensure that each service location has enough stock to meet the needs of their regular customers. Stock levels and the products offered can be customized to each location based on historical customer preferences. This reduces the chance of the location running out of high demand items. Additionally, tracking customer preferences allows each location to identify and replace low demand items with new items or seasonal items better suited for the customer preferences.

### Specific Applications

The process outlined above could be implemented in a variety of different environments. For example, restaurants with instore lines or drive throughs. Alternatively, it could be used to assess if a customer would arrive on time fora restaurant reservation. Airlines could use the process to assess if a passenger would arrive on time to make a flight and could predict if there will be last minute availability. While there are a variety of different services environments in which the process could be implemented, examples of the advantages of its use in a food truck café and a grocery delivery environment are outlined below.

### Food Truck Café

This system is particularly useful in a café type environment, particularly where the service location is a food truck strategically located between main residential areas and workplace clusters. For example, in the suburbs, there typically are not many coffee locations close to residential and industrial or office space areas. Where there are locations, these are typically plagued by long lineups in store and in the drive-thru. Thus, the food trucks could be used for just in time orders for the suburban commuters. By tracking the customer location and adjusting the production queue based on real time or near real time customer location updates, the food truck can supply the customer with freshly prepared orders with the added convenience of not having to wait at a drive through or having to go into a café to have their order prepared. Additionally, the production queue is adjusted automatically if the customer is delayed, so food is not left sitting waiting for pick up.

The system can use the tracked user location data to determine the best locations to place their trucks based on the user starting locations, routes taken and the user end locations. This allows the food truck to locate itself in area of high-volume traffic and users.

Tracking of orders and volume using the cloud server 8 allows the food truck to implement many of the advantages of finite capacity scheduling, typically used in industrial environments, in the café environment. Finite capacity scheduling is an approach to understanding how much work can be produced in a certain time period, taking limitations on different resources into consideration. The goal of finite capacity scheduling is to ensure that work proceeds at an even and efficient pace throughout the service locations. The service device 6 can track orders and productivity in real time. This advantages of knowing instantaneously and tracking what is happening in the truck allows for improved predictions of preparation times needed for each order which can adapt to real time productivity of the truck staff, optimized ordering and stocking of supplies and goods in the truck based on previous order patterns leading to less waste and minimized production costs, and automatic staffing changes or support if the truck is behind schedule.

### High Volume Food Truck Café

The system can be modified to be adapted and optimized for high-volume order applications. For example, a food truck could be stationed outside a train station to serve commuters. In this high-volume example, customers would be arriving in waves corresponding to the departures of trains, with thousands of clients placing orders within a brief period of time. Customers would arrive before their train departure time, peaking approximately 15 minutes before train departure. It's possible to have up to a hundred or more customers arriving within a 15 minute period to pick up their orders before they get ready for the train. Furthermore, within these high-volume periods, the truck will need to meet hard deadlines based on train departure times. Most customers will abandon the truck and their order in order to board the train as very few will miss the train in order to pick up their order. In this high-volume environment, conventional restaurant service methods will not be able to service this extent of a rush.

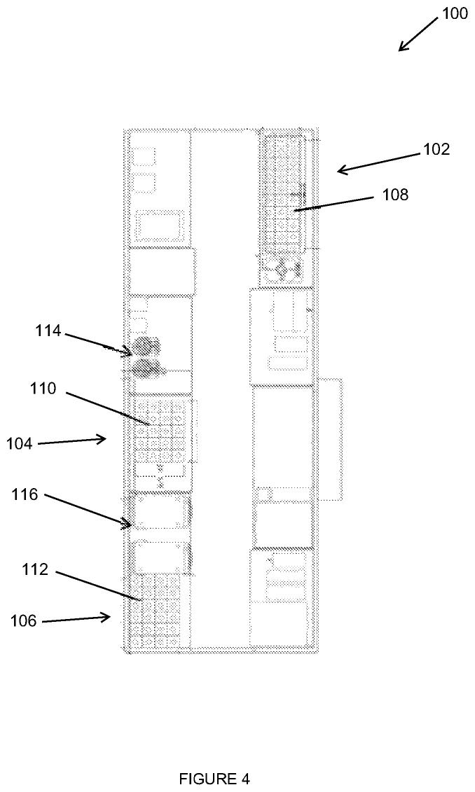

There are several adaptations that can help address issues associated with high-volume ordering environments. First, the food truck can be divided into a plurality of pick up zones. While the number of pick up zones could vary based on the truck size and layout, in a preferred embodiment, there are 3 zones. These zones are shown in a schematic of a truck 100 in FIG. 4 and include zone A 102 at the front of the truck, zone B 104 in the middle of the truck, and zone C 106 at the rear of the truck. Each zone is provided with a pickup location, for example a door or window through which the customers are serviced. By using multiple service locations, the orders can each be assigned to a zone and thus the customers can be split into groups. This allows for parallel processing of orders and parallel delivery of the orders to customers. By providing a plurality of pick up zones, the wait time for picking up an order is reduced. This method also allows each zone or workstation to work at their own pace, as long as they complete their order list before the customer arrives at the truck (i.e. as long as the estimated time to arrival, shown in box 40 of FIG. 2, is greater than zero).

In the preferred embodiment, an algorithm is used to assign each order to a zone and spread the orders and pickups across the zone pick up locations. This allows for optimization and increased efficiency of both production and pickups to be optimized. If an order has multiple items, all items in the order would be marked with the same pick up slot number. Items can be marked in a variety of different ways, however in a preferred embodiment, items are marked on the bag, product box or cup with stickers, tickets or tags printed at each workstation or zone. In the preferred embodiment, each zone has a plurality of “pickup slots” or other suitable identifier, for the location of a filled order. In the preferred embodiment, the pick of slot number is “row” and “column” arrangement that makes it easy to find a slot both when staging the freshly made product, and when the customer picks up their order. Examples of these slots are shown generally in figure four as reference characters 108, 110 and 112 for zone A 102, zone B 104 and zone C 106, respectively. Each pick up slot is associated with a zone and has its own unique identifier.

As an order transitions to the production queue, the system can assign an order pick up slot number, and thus also assign a zone, based on one or more factors. In one embodiment, the assignment of a pickup slot is based on the type of order. For example, if a mobile order is placed for a beverage only, the order would be assigned an available slot number in a zone close to the beverage station. In the example layout shown in FIG. 4, this would be zone A 102 in which the coffee station 114 is located. However, if the mobile order included both an oven item and a beverage, the order may be assigned a pickup slot in zone C 106 which is closest to the ovens 116. Then perhaps zone B 104 would be reserved for walk up orders as it is closest to the front window.

Alternatively, pickup slot assignment could be assigned based on the size of the order. For example, small or single item orders could be processed in zone A 102, with multiple item orders processed in zone B 104 (most multiple order items include at least one food item) and large oversized orders could be processed in zone C 106 or could be picked up at a designated section of the truck set aside for oversized orders.

It can be appreciated that various different criteria, including but not limited to size of order, type of order, products ordered, volume of orders pending in each zone, distance of customer to truck or time to prepare the order, could be used in order to assign pick up slots. While the two examples given above have been described separately, a person skilled in the art would appreciate that several criteria could be used in combination to assign the best pick up slot. For example, size of order and order volume for each zone could be used, or size of order and type of order could be used to optimize the pickup slot location.

Slot number can be communicated to the customer as a “pickup number” and is preferably transmitted to the customer app when the pickup slot number is auto assigned. Customers arrive (at the designated pickup location) and tell the crew their “pickup number” and the crew can quickly find the customer order and deliver it efficiently. In a preferred embodiment, the customer location is tracked via their phone location and the customers will not need to “announce” themselves as the arrival of their phone will be known. Crew members quickly mark the order as picked up using any suitable method, for example, by hitting a button beside the slot number on the order screen.

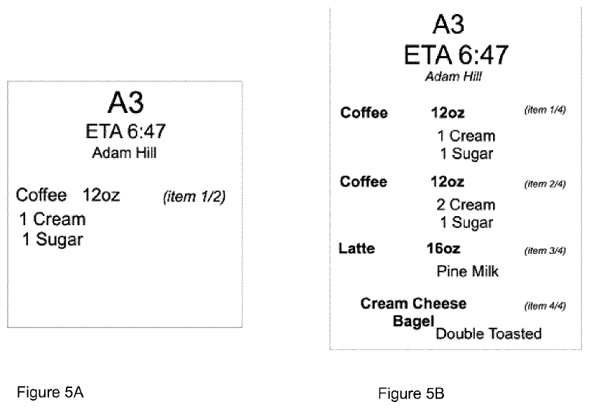

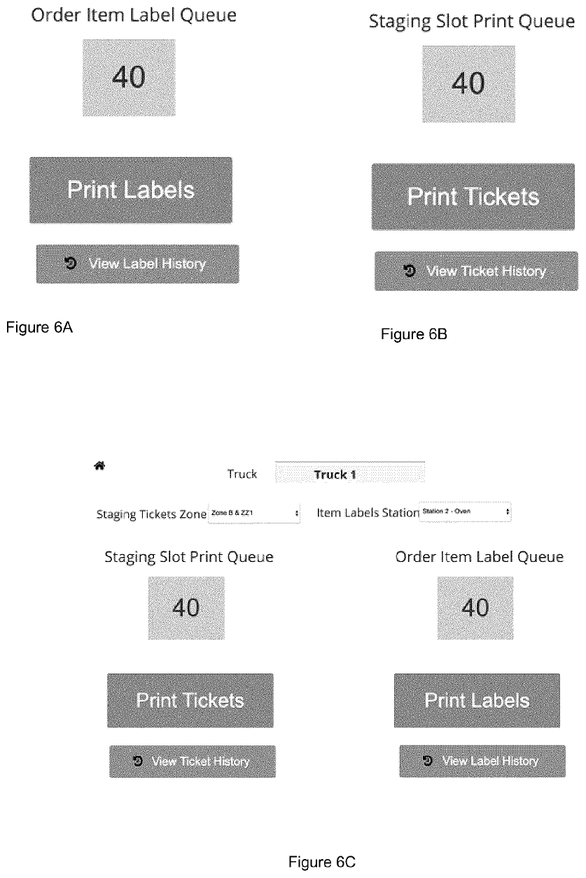

The system can be further optimized by using the Kanban productivity model. Once an order has transitioned to the production queue and has been assigned a pickup slot number, each item in the order is sent to an order item label queue to await printing. An example of an item ticket is shown in FIG. 5A. The item ticket would include information pertaining to the order such as the pickup slot, item ordered, number of items in the order and estimated time of arrival of the customer. It can be noted that the information on the ticket can vary, but at least the pickup slot identifier and item particulars should be included. Each zone has its own order item label queue. The tickets remain in this queue until a crew member in the relevant zone requests to print the order item tickets. Once printed, the ticket is placed on the relevant cup, bag, box or other packaging and the order is prepared for pickup. It should be noted that the sequence of the various items for preparation in the item label queue can be rearranged based on the estimated time to arrival or location of the customer using the process described in FIG. 2. A crew member in each zone, uses computer system, preferably a touch screen, to request an item ticket to be printed, and the tickets are printed at a printer closest to the relevant zone. It can be appreciated that a truck could be configured with a single printer, however a plurality of printers is preferred. In the preferred embodiment, at least one printer per zone is provided. In this manner, tickets are printed by the responsible crew member in an “on demand” fashion and can print once they are ready to make the order. In the preferred embodiment, when a crew member request tickets to print, a batch of tickets for multiple orders is printed. The batch size can be adjusted to the optimum number for the preference of a particular crew, however batches of 3-10 orders are preferred. This screen, shown in FIG. 6A can also show the number of unprinted tickets or items that remain in the queue. This can be used as a guide by the crew members to know how quickly they must work. When the number is high (for example, greater than 10) the crew members knows they must work quickly and/or ask another crew member to assist to speed up production.

Optionally, when the order is sent to the order item label queue, the entire order can be sent to a staging slot print queue. As shown in FIG. 5B, the slot tickets in this queue contain information about each item in the order. The slot tickets are sent to a staging slot print queue to await printing. Each zone has its own staging slot print queue. The tickets remain in this queue until a crew member in the relevant zone requests to print the slot tickets. Once printed, the ticket is placed in the corresponding pickup slot. Since the slot ticket shows all the items in the order assigned to a particular slot, this ticket acts as a double check to ensure the order is complete. In this embodiment, information as to how many slot tickets are in the queue can also be displayed on the screen, as shown in FIG. 6B. In yet a further embodiment, the staging slot print queue and order item label queue are shown together on the screen, an example of which is shown in FIG. 6C.

### Marketing Applications

The data collected using the system described above, can also be used to implement various marking promotions. For instance, information regarding the customer time to arrival could be used to identify if the customer walked or drove to the retail venue. In embodiments where it may be beneficial to the retail owner or a service provider to have customers walk to the venue, particular promotions could be offered to them electronically on the app. Alternatively, information pertaining to the customer's order preferences, cost of purchases or frequency of purchases could be used to determine promotions tailored to the customer.

This embodiment is particularly useful in applications where tracking how a customer travelled to get to the venue is important. For example, in the embodiment where the truck is situated outside a train station, it would be beneficial to the train company to have customers walk to the train. This increases train ridership by freeing up parking spaces so more drive-in customers can ride the train. The data collected by the system disclosed herein, could be used to determine if the customer walked to the train station and can also be used to track their movement after their arrival at the train station to determine if they boarded a train. If they both walked and boarded a train, particular promotions could be applied to their account.

In this embodiment customer behavior can be tracked and both supervised and unsupervised machine learning could be used to determine if a customer has completed a predetermined set of conditions to qualify for a promotion.

### Grocery Store

This system could also be used in an online ordering and pick up system typically used at grocery stores. The user chooses their items and places their order. Based on the customer location and estimated time to the service location, the service device 6 notifies a staff member when it is an appropriate time to gather all the items for “just-in-time” delivery to the customer. This ensures that items are not sitting out for too long while the store is waiting for the customer to arrive. As one can appreciate, this minimizes the time that frozen or refrigerated foods are removed from the freezer or refrigerators.

Additionally, the software could be used to group orders for the staff member to gather. If more than one customer is arriving at similar times, the service device 6 advises a staff member to collect both orders at the same time, reducing the time it takes for staff to prepare the order.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

What is claimed is:

1. A method of providing an order to a customer comprising;
h) receiving an order from a user device;
i) determining the preferred delivery location;
j) assigning at least one preparation time to the order;
k) receiving a user device location;
l) using the user device location and order preparation time, determining if the order should be placed in a production queue to be prepared for delivery;
m) repeating steps d and e until the order is put in the production queue; then
n) determining if the user device is at the preferred delivery location; and
when the user device is at the preferred delivery location, providing the order.

2. The method of claim 1 wherein step e further comprises using the user device location and preferred delivery location to determine an estimated time to arrival and comparing the estimated time to arrival to the order preparation time to determine if the order should be placed in a production queue.

3. The method of claim 2 wherein the step of assigning the order at least one preparation time includes grouping the items into categories and assigning each category an order preparation time.

4. The method of claim 2 wherein the step of assigning at least one preparation time includes assigning a preparation time to each item in the order.

5. The method of claim 3 wherein the estimated time to arrival is used to assign one of a number of predetermined geozones and depending on the geozone assigned, adjusting the frequency of receiving the user device location.

6. The method of claim 5 wherein after the order is put in the production queue a pickup slot location is assigned.

7. The method of claim 6 wherein the pickup slot location is communicated to the user device.

8. The method of any one of claim 8 wherein isochrones and isoclines are used to determine the estimated time to arrival.

9. A system for sequencing a series of orders for production comprising:
an order tracker for receiving orders and corresponding user device locations;
said order tracker having a first database for storing items from incoming orders and corresponding user device locations, and a second database for storing the preparation times associated with each item available for order;
said order tracker further comprising a processing means to assign each item in each order the corresponding prep time and assign an estimated time to arrival to each order based on the associated user device location;
said processing means configured to receive periodically updated user device locations and update said first database with a new estimated time to arrival;
said processer further configured to use said preparation times and new estimated time to arrival to determine if an order should be prepared;
once the order is to be prepared it is displayed on a screen at a service location.
